(19) United States
(12) Patent Application Publication
(10) Pub. No.: US 2005/0210260 A1
(43) Pub. Date: Sep. 22, 2005

(54) Unimodular matrix-based message authentication codes (MAC)

(76) Inventors: Ramarathnam Venkatesan, Redmond, WA (US); Matthew C. Cary, Seattle, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/803,108

(22) Filed: Mar. 17, 2004

(51) Int. Cl. G06F 12/00

(52) U.S. Cl. 713/180

(57) ABSTRACT

The present invention leverages the invertibility of determinants of unimodular matrices to provide a universal hash function means with reversible properties and high speed performance. This provides, in one instance of the present invention, length controllable hash values comprised of vector pairs that can be processed as one instruction in a SIMD (single instruction, multiple data) equipped computational processor, where the vector pair is treated as a double word. The characteristics of the present invention permit its utilization in streaming cipher applications by providing key data to seed the ciphering process. Additionally, the present invention can utilize smaller key lengths than comparable mechanisms via inter-block chaining, can be utilized to double hash values via performing independent hash processes in parallel, and can be employed in applications, such as data integrity schemes, that require its unique processing characteristics.

### TECHNICAL FIELD

The present invention relates generally to data protection, and more particularly to systems and methods for providing a message authentication code based on unimodular matrices.

### BACKGROUND OF THE INVENTION

Since the beginning of the digital revolution, there has always been a concern that not all of the digital bits sent from point A to point B will arrive intact. This is because, whether malicious or non-malicious attacks, the digital information sometimes arrived in an altered state at its destination. Depending on the criticality of the transmitted data, the altered information could be inconsequential or might be of significant importance such as transferring one million dollars to a bank account instead of one hundred dollars to a bank account. Therefore, a means to verify and check data is required to ensure that what information was sent actually arrived in the same form. Additionally, especially in the banking example just mentioned, it is also highly desirable to ensure that the data came from a particular source. Thus, it is necessary to also have a means to verify and/or identify the sender of the information. Otherwise an individual could just send the information to the bank and transfer money into their account at will. Likewise, it is also desirable to hide, or encrypt, the information being sent so that other parties cannot view the data. All of these desirable characteristics for transmitted data tend to have equal importance for secure data transmissions in today's digital environment.

One way to ensure that data arrives exactly as it was sent is to provide information along with the transmitted data that provides a method to double check that all of the data bits have been received and, sometimes, even that they are in a particular order. This is often accomplished with a “checksum” value that is sent or appended to the transmitted data. This checksum can be as simple as the value of adding up all the bits or as complicated as a value that can indicate, to a high degree of probability, the order and value of all the digital bits. Thus, checksum methods can be quite complex, depending on the depth of checking required in a given circumstance. Critical data, for example, such as airplane flight control information, can require extremely thorough checksum values. Other means of ensuring data integrity can include sending redundant copies of the data and doing a data comparison at the receiving end. This is valid as long as the attacks to the data tend to be non-malicious and random. A malicious attack or a reoccurring error can affect all redundant copies of the data, yielding no means to adequately decide which data set is correct.

It is also desirable to be able to authenticate that data was sent by a particular party. Thus, when an email is received, for example, one assumes that it was sent from the party in the “from-line” of the email. However, as is common with email viruses, the virus sends emails to users in an address book of an infected computer and alters the from-line so that the emails appear to be from someone other than the virus program. Therefore, if the received communication is of a highly critical nature, the receiving party would like to be ensured that the email originated from the sender and not from anyone else. This is especially important in a business environment where the digital information is utilized to make business decisions and to conduct business transactions. It is also critical in medical settings such as transmitting drug prescriptions and medical information and the like.

As the digital age has progressed, it has become very easy to send, receive, and manipulate digital data. Although this digitally-provided power is typically utilized to enhance and enrich society, it can also be utilized to maliciously alter and/or intercept data. People, along with businesses, often tend to send information that is of a sensitive nature, and they do not want it to be disseminated to parties other than those to which the data was sent. Therefore, if the data is intercepted by a third party, they would like the data to be meaningless to that third party. This is typically done by encrypting data utilizing a “key.” The data can then only be unlocked by possessing and utilizing the digital unlock key. Generally, to gain more security, the encryption key is lengthened to contain more digital bits. The encrypting method can also become extremely complex in order to provide even more security for the transmitted data.

As technology has progressed in the aforementioned data protection areas, it has tended to somewhat merge into overlapping methods that provide data protection in multiple facets. Thus, an authentication method that verifies who the data was sent from is often also combined with an encryption scheme to hide the data from third parties. Likewise, an encryption scheme might also provide a data integrity scheme, and a data integrity scheme might also be utilized to verify who sent the digital data. Some current authentication schemes utilize “public keys” and “secret” or private keys to facilitate authentication. These methods often incorporate a “message authentication code” or MAC that is a hash value (a fixed length digital code) that is representative of the actual input data. The MAC is typically encrypted along with the data itself and sent to a party. The party then decrypts the data and generates a new MAC on the data. The received MAC and the new generated MAC are then compared to verify that the data is intact and can sometimes also be utilized to authenticate the sender of the information.

As society creates more and more digital information, the sizes of transmitted data also increase dramatically. Thus, despite advances in technology with regard to faster processors and better data management, the amount of digital information being sent can be immense. This creates a workload for digital protection schemes that can become overwhelming for a particular process. Typically, users will not tolerate lengthy delays after they command data to be transmitted. This additional time for providing data protection is seen as an encumbrance to this method of data transmission. Although a user deems the protection necessary, time constraints may cause a user to by-pass data protection in order to timely send out large amounts of data, exposing the data to interception/disclosure, spoofing, and alterations. Efficient, secure, and adjustable data protection schemes can provide businesses and individual users alike with the capability to expand beyond their current data size limitations without limiting their data protection due to intolerance of data protection overhead costs.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates generally to data protection, and more particularly to systems and methods for providing a message authentication code based on unimodular matrices. The invertibility of determinants of these types of matrices is leveraged to provide a universal hash function means with reversible properties and high speed performance. This provides, in one instance of the present invention, length controllable hash values comprised of vector pairs that can be processed as one instruction in a SIMD (single instruction, multiple data) equipped computational processor, where the vector pair is treated as a double word. By providing single instruction processible hash values, one instance of the present invention can compute the hash values at a 500 megabyte per second input data rate on a 1.06 gigahertz processor. The characteristics of the present invention permit its utilization in streaming cipher applications, and it can be utilized to provide key data to seed the ciphering process. Additionally, the present invention can utilize smaller key lengths than comparable mechanisms via inter-block chaining, can be utilized to double hash values via performing independent hash processes in parallel, and can be employed in applications that require its unique processing characteristics. Thus, the present invention provides a high performance hash value generation means that can also be utilized to facilitate cipher key seeding and utilized to facilitate other data protection schemes, such as, for example, checksumming and the like.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a data transformation system in accordance with an aspect of the present invention.

FIG. 2 is another block diagram of a data transformation system in accordance with an aspect of the present invention.

FIG. 3 is a block diagram of a data encryption system in accordance with an aspect of the present invention.

FIG. 4 is a block diagram of a reversible data transformation system in accordance with an aspect of the present invention.

FIG. 5 is a graph illustrating the k-invertibility of A₅₀ in accordance with an aspect of the present invention.

FIG. 6 is a graph illustrating the k-invertibility of Bₜ versus the log_{1.5} t in accordance with an aspect of the present invention.

FIG. 7 is a flow diagram of a method of facilitating data transformation in accordance with an aspect of the present invention.

FIG. 8 is another flow diagram of a method of facilitating data transformation in accordance with an aspect of the present invention.

FIG. 9 is yet another flow diagram of a method of facilitating data transformation in accordance with an aspect of the present invention.

FIG. 10 is a flow diagram of a method of facilitating a data transformation value length in accordance with an aspect of the present invention.

FIG. 11 is a flow diagram of a method of facilitating inter-block chaining for a data transformation in accordance with an aspect of the present invention.

FIG. 12 is a flow diagram of a method of facilitating data encryption in accordance with an aspect of the present invention.

FIG. 13 illustrates an example operating environment in which the present invention can function.

FIG. 14 illustrates another example operating environment in which the present invention can function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

The present invention provides a MAC construction based on modular groups. Each input is embedded into a sequence of matrices with determinant ±1, the product of which yields a desired MAC. The invertibility and the arithmetic properties of the determinants of certain types of matrices are utilized for analysis and can be of interest in other applications. Algorithms to compute message authentication codes (MACS) are important in security applications, and the task of constructing them rigorously and efficiently is well-studied. Recent algorithms have utilized a secret key to map an input into a short binary string, and then secure the result with a block cipher or traditional secure hash. The present invention provides a method for the first step, the so-called universal hash function. It provides a construction based on modular groups that is competitive or better than other methods. The present invention can also be utilized with document indexing and retrieval, document integrity checking for databases and secure networks, and web search and server applications and the like.

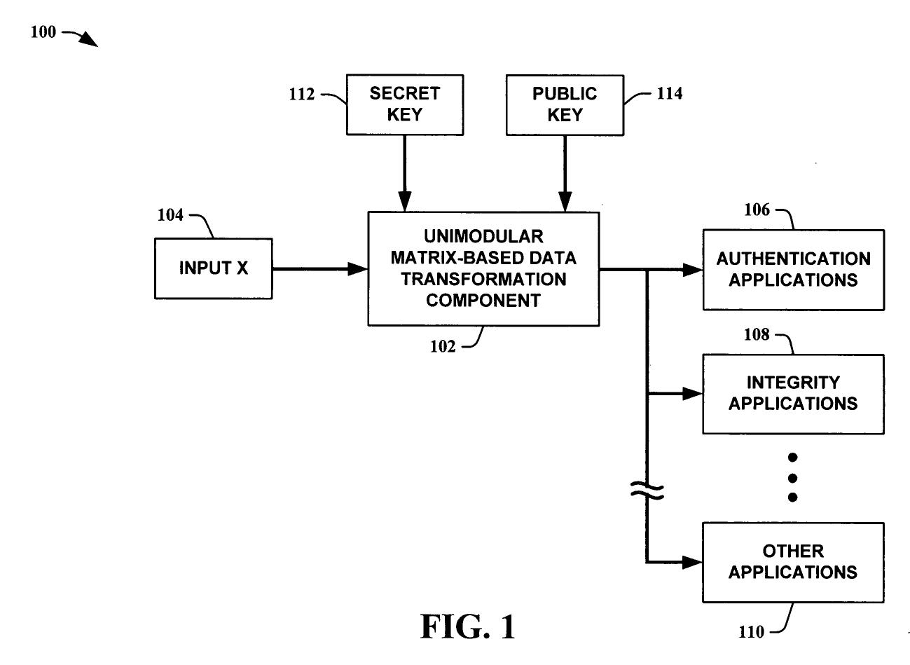

In FIG. 1, a block diagram of a data transformation system 100 in accordance with an aspect of the present invention is shown. The data transformation system 100 is comprised of a unimodular matrix-based data transformation component 102 that transforms input data X 104 and outputs data for applications such as authentication applications 106, integrity applications 108, and other applications 110. The other applications 110 can be comprised of, but are not limited to, applications such as encryption, web search, and server applications and the like. In another instance of the present invention, the unimodular matrix-based data transformation component 102 can output data in the form of a message authentication code (MAC) for utilization with authentication applications 106 and/or integrity applications 108 and the like. Thus, the MAC not only provides an indication of who sent the data, but can also be utilized to determine if the input data X 104 has been altered. The unimodular matrix-based data transformation component 102 receives the input data X 104 and transforms it into a transformation value utilizing at least one secret key 112 and at least one public key 114. The public key 114 can be comprised of public matrices with determinants of ±1. Generally, in one instance of the present invention, the unimodular matrix-based data transformation component 102 generates the transformation value in the format of a vector pair from a unimodular group employing the public matrices. Details of the processing of the input data X 104 are discussed infra.

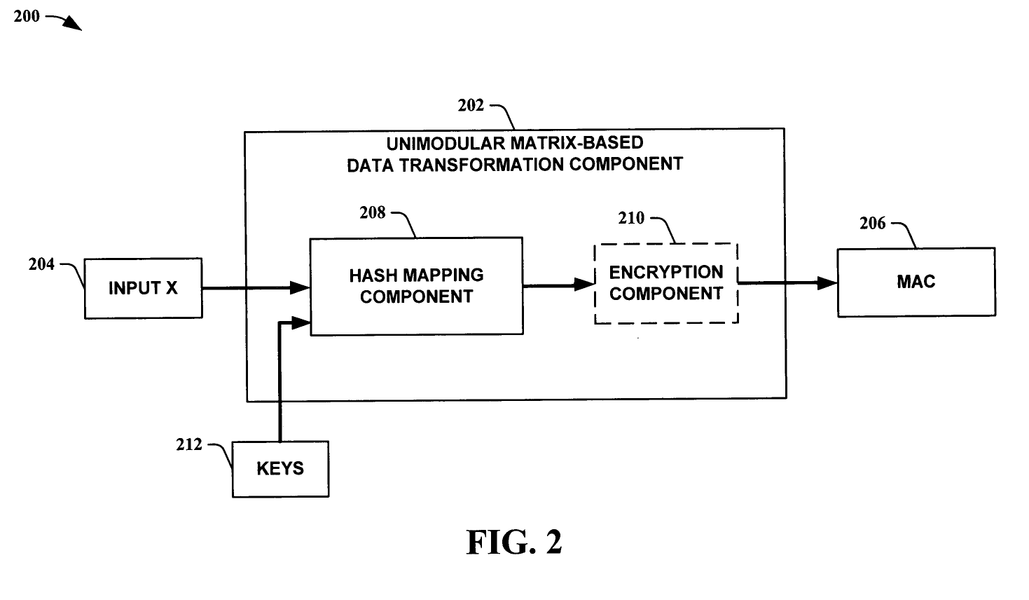

Referring to FIG. 2, another block diagram of a data transformation system 200 in accordance with an aspect of the present invention is illustrated. The data transformation system 200 is comprised of a unimodular matrix-based data transformation component 202 that receives input data X 204 and outputs MAC data 206. The unimodular matrix-based data transformation component 202 is comprised of a hash mapping component 208 and an optional encryption component 210. The hash mapping component 208 receives the input data X 204 and transforms the input data X 204 into a hash value utilizing keys 212 and a universal hash function with reversible properties. The resulting hash value can then be output as the MAC data 206 and/or it can be encrypted via the optional encryption component 210 and then output as an encrypted form of the MAC data 206. The hash mapping component 208 maps the input data X 204 by processing it with keys 212 that provide authentication and/or data integrity characteristics and the like to the calculated hash value.

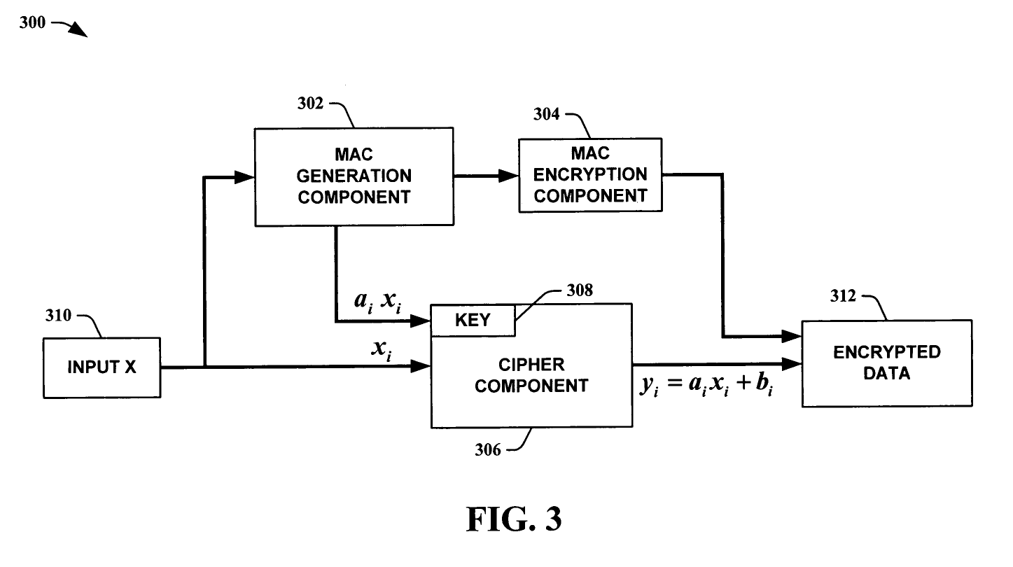

Looking at FIG. 3, a block diagram of a data encryption system 300 in accordance with an aspect of the present invention is depicted. The data encryption system 300 is comprised of a MAC generation component 302, a MAC encryption component 304, and a cipher component 306 utilizing at least one key 308. The data encryption system 300 receives input data X 310, transforms and encrypts the input data X 310, and then outputs encrypted data 312. The encrypted data 312 is comprised of an encrypted form of the input data X 310 and an encrypted form of a MAC relating to the input data X 310. In other instances of the present invention, the MAC can be appended to the encrypted form of the input data X 310 without being encrypted and/or the MAC generation component 302 can solely be utilized to seed the cipher component 306. In the present instance of the present invention, the input data X 310 is received by both the MAC generation component 302 and the cipher component 306. The MAC generation component 302 transforms the input data X 310 into a hash value utilizing unimodular matrices and outputs the hash value to the MAC encryption component 304. Since the present invention's operations are invertible, they can be combined with authentication and encryption via employment of stream ciphers that utilize a final hash value to define a key for generation of a one-time pad. Thus, the MAC generation component 302 also produces seed data for the key 308 of the cipher component 306. In this instance of the present invention, the cipher component 306 utilizes a function to encrypt the received input data X 310 in the form of yᵢ=aᵢxᵢ+b₁, where aᵢ and bᵢ are random key words and aᵢxᵢ is generated by the MAC generation component 302. The cipher component 306 then outputs the encrypted form of the input data X 310 as a portion of the encrypted data 312.

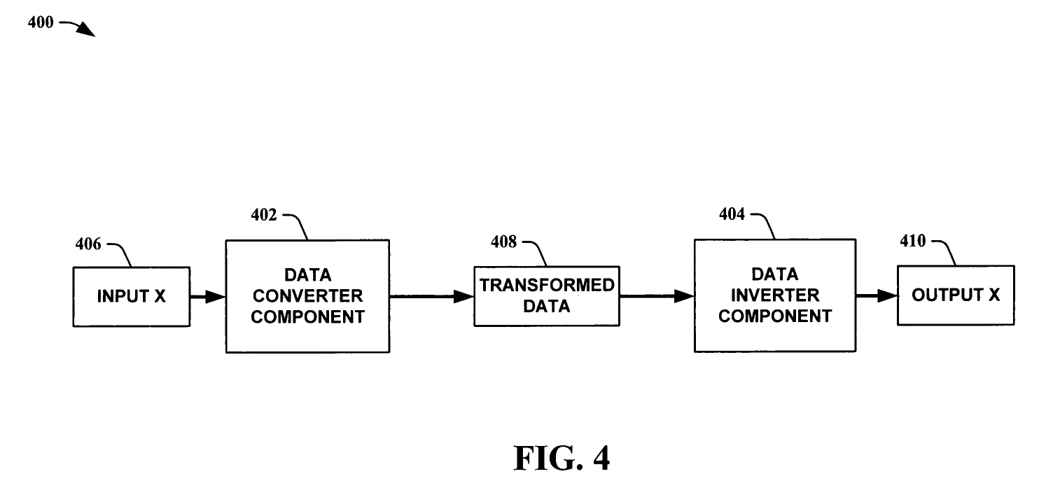

Turning to FIG. 4, a block diagram of a reversible data transformation system 400 in accordance with an aspect of the present invention is shown. The reversible data transformation system 400 is comprised of a data converter component 402 and a data inverter component 404. In other instances of the present invention, the reversible data transformation system 400 can be comprised solely of the data converter component 402 or solely of the data inverter component 404. In this example of the present invention, the reversible data transformation system 400 receives input data X 406 and employs the data converter component 402 to transform it via a unimodular matrix-based transformation process into transformed data 408. The transformed data is then received by the data inverter component 404, and the transformation process is reversed, producing output data X 410. The data converter component 402 is typically comprised of a unimodular matrix-based data transformation component. Thus, the transformed data can be a hash of the input data X 406. Generally, a hash is defined as a one-way transformation of data into a fixed-length representation. However, the present invention provides a means to reverse the hash and derive relevant information as to the content of input data X 406 and/or characteristics related to authentication of the input data X 406. This is a characteristic only provided by the present invention.

The unique qualities of the present invention are better perceived by understanding the context of the present invention. Algorithms to compute message authentication codes (MAC) are important in security applications, and the task of constructing them rigorously and efficiently has been a subject of many technological endeavors. An introduction can be found in Alfred J. Menezes, Paul C. van Oorschot, and Scott A. Vanstone; Handbook of Applied Cryptography; CRC Press, 1997.

Recent MAC algorithms utilize a secret key K to map an input X into a short binary string h=H_{K}(X) of some fixed length [see, (J. Black, S. Halevi, H. Krawczyk, T. Krovetz, and P. Rogaway; UMAC: Fast and Secure Message Authentication; Lecture Notes in Computer Science, 1666:216-233, 1999), (S. Halevi and H. Krawczyk; MMH: Software Message Authentication in the Gbit/Second Rates; In Fast Software Encryption, pages 172-189, 1997), (Phillip Rogaway; Bucket Hashing and Its Application to Fast Message Authentication; Journal of Cryptology: the Journal of the International Association for Cryptologic Research, 12(2):91-115, 1999), (M. Bellare, R. Canetti, and H. Krawczyk; Keying Hash Functions for Message Authentication; Lecture Notes in Computer Science, 1109, 1996), (V. Shoup; On Fast and Provably Secure Message Authentication Based on Universal Hashing; Lecture Notes in Computer Science, 1109, 1996), and (M. H. Jakubowski and R. Venkatesan; The Chain and Sum Primitive and Its Applications to MACs and Stream Ciphers; In Advances in Cryptology—EUROCRYPT '98, volume 1403 of Lecture Notes in Computer Science, pages 281-293; Springer-Verlag, 1998)].

After the mapping is completed, h is encrypted utilizing a block cipher. If the cipher acts as a random permutation, the encryptions of the hash values hᵢ, . . . , h_{q} of q distinct inputs X₁, . . . , X_{q} can not be distinguished from truly random outputs of the corresponding length, if the hash values hᵢ=H_{K}(Xᵢ) are distinct. Thus, if a secure cipher is utilized, the collision properties of the hash function determine the security of the MAC. The main parameter of interest for a MAC algorithm is the collision probability Pr_{K} [H_{K}(X)=H_{K}(X′)], where X and X′ are arbitrary and distinct inputs. If the collision probability is the inverse of the size of the range of the hash, regardless of the choice of inputs, the hash function is called a universal hash function (see, Carter and Wegman; New Hash Functions and Their Use in Authentication and Set Equality; Journal of Computer and System Sciences, 22(3):265-279, 1981). This approach has enabled construction families of hash functions with quantifiable collision probabilities that are remarkably fast in practice. The initial mapping X [symbol] h and its collision probability is a focal point, and it is assumed for simplicity that all inputs have the same length and can be subdivided into blocks evenly.

To better understand the present invention's construction, it is helpful to review some earlier construction techniques. In one such technique, an evaluation MAC identifies an input message X=x₁, . . . xₘ with a polynomial of degree m over a suitable field and computes the map α [symbol] Σᵢ xᵢαⁱ for a random α. Bernstein's hash 127 (D. Bernstein; Floating-point Arithmetic and Message Authentication; Draft available at http://cr.yp.to/papers/hash127.dvi) implements a polynomial evaluation hash utilizing floating-point operations in an efficient and platform independent manner.

Many MAC constructions utilize a standard iterative rule yᵢ=fᵢ(xᵢ+yᵢ₋₁), where yᵢ are the intermediate values and various methods utilize different fᵢ's. In the evaluation MAC, fᵢ(x)=f(x)=αx, the iteration is Horner's rule and yₘ is the final value. If one takes fᵢ=f(x)=E_{K}(x) to be a block cipher, one gets the CBC MAC [see, The Security of the Cipher Block Chaining Message Authentication Code (M. Bellare, J. Kilian, and P. Rogaway; Journal of Computer and System Sciences, 61(3):362-399, 2000) for an analysis and On Fast and Provably Secure Message Authentication Based on Universal Hashing (Shoup, 1996) for an efficient implementation].

The chain and sum method (Jakubowski and Venkatesan, 1998) doubles the length of the hash in a one-pass computation by outputting the pair (yᵢ, Σyᵢ) . It is similar to the evaluation MAC, except it alternates two random affine transformations f and g of the form x [symbol] ax+b. That is, fᵢ=f for odd i, and fᵢ=g for even i. To improve the present invention's collision probabilities, the summing method is utilized, which was employed in The Chain and Sum Primitive and Its Applications to MACs and Stream Ciphers (Jakubowski and Venkatesan, 1998) to obtain a pseudo-random permutation on X by further encrypting y₁, . . . yₜ₋₂ with a one-time pad derived from (yₜ, Σ yᵢ) utilizing a stream cipher and encrypting (yₜ, Σ yᵢ) with a block cipher.

These methods work over a field, where operations are typically expensive on standard processors. Working instead with modulo 2^{l} is advantageous and the fastest MACs utilize this method. However, the ring of integers modulo 2^{l} does not have the invertibility which is crucial for analysis. For example, for x≠x′, the function f(x)=αx+b over a field has an invertible output differential f(x)−f(x′)=α(x−x′) in the sense that it is uniformly distributed if α is randomly chosen. However, for modulo 2^{l}, this changes sharply. If 2^{k}|(x−x′)m, then 2^{k}|(y−y′), and if k=l−1 the output is distributed as a set of size 2 for a random odd α. The present invention constructs reversible transformations that are suitable for MAC and other applications. Proof for the present invention mimics the proof in the finite field case, except the present invention's equations involve coefficients from matrix groups.

UMAC (see, Black, Halevi, Krawczyk, Krovetz, and Rogaway, 1999) is an efficient MAC algorithm that achieves high speeds by utilizing SIMD instructions available on many CPUs for media processing. UMAC utilizes the iteration yᵢ=f(x₂ᵢ, x₂ᵢ₊₁)+yᵢ₋₁, where f(x₀,x₁)=(x₀+k₀)·(x₁+k₁). Here the kᵢ are secret random words, and the multiplication is reduced at twice the word size of the xᵢ. For example, the xᵢ are 32 bits, and the yᵢ 64 bits. In UMAC: Fast and Secure Message Authentication (see, id), it is shown that the reduction modulo powers of two, while not totally universal, is nearly so. Leveraging the media processing instruction set allows UMAC to achieve a rate faster than a byte per cycle, meaning gigabyte per second rates on today's processors.

Klimov and Shamir (see, A. Klimov and A. Shamir; A New Class of Invertible Mappings; Crypto 2001 Rump Session) constructed an elegant family of invertible mappings (modulo 2^{l}) that combine arithmetic and boolean operations to get non-linear maps for utilization in cryptographic primitives. The present invention can incorporate these functions after they have been randomized and modified per the present invention to have suitable differential properties.

The present invention's inputs are broken into blocks of length t words, each of size l-bits. A given l-bit input xᵢ is embedded into a 3×3 matrix Bᵢ over the ring of integers modulo 2^{l} by xᵢ

$${x}_{i} ↦ [ \begin{matrix}{A}_{i} & {v}_{i} \\ 00 & 1\end{matrix} ] \text{=} \text{:} {B}_{i} ,$$

where vᵢ=fᵢ(xᵢ) is a vector with two elements, and Aᵢ is a 2×2 matrix with det(Aᵢ)=±1; here the sequence of Aᵢ's is fixed independent of the input xᵢ. The Aᵢ sequence utilized by the present invention is periodic, so that the implementation can be unrolled and have a small code footprint. The function, fᵢ(x), is defined by multiplication with random odd aᵢ where aᵢ and x are l bits, and the 2l bit result is viewed as a vector of two l-bit numbers. Thus fᵢ(x) is invertible modulo 2^{2l} and can be implemented in one instruction utilizing the usual 2l-bit result of multiplication of two l-bit quantities.

For each block of input, the product

$$B = [ \begin{matrix}A & z \\ 00 & 1\end{matrix} ]$$

of these matrices Bᵢ is computed. The output of the present invention's hash value is the pair

$$( z , {\sum }_{i = 1}^{i} {v}_{i} ) .$$

The collision probability is substantially near 2^{-2l} by utilizing the invertibility of Aᵢ and the arithmetic properties of the determinants of the matrices of the form

$${\prod }_{i = j}^{k} {A}_{i} - I$$

over [symbol] (and not modulo 2^{l}). The present invention offers simplicity and can also facilitate applications other than MACs as well.

The present invention's construction can be viewed in a more general manner.

Let G=SL₂ [symbol] and [symbol] so that G is the group of unimodular matrices over multiplication, and H is the group of 2-dimensional vectors modulo 2^{l} over addition. The natural homomorphism taking elements of G to automorphisms of H via the matrix-vector product defines a semidirect product G [symbol] H. The present invention's block hash is then an embedding of the input into G [symbol] H by mapping xᵢ to (Aᵢ, fᵢ(xᵢ)). The product of these elements is that over G [symbol] H. Given appropriate fᵢ, the present invention's construction can be generalized to larger matrices.

Many efficient MAC algorithms are available [see, (Shoup, 1996), (Halevi and Krawczyk, 1997), (Black, Halevi, Krawczyk, Krovetz, and Rogaway, 1999), (Rogaway, 1999), and (Bernstein). Several work by expanding a short key to a large key for an inner hash function utilizing a pseudo-random generator; the large key can amount to a fraction of the length to be hashed. However, the present invention's algorithm requires less key to be generated than algorithms such as UMAC. This is highly desirable in some applications.

Even though the present invention is slower than the fastest algorithm, UMAC (Black, Halevi, Krawczyk, Krovetz, and Rogaway, 1999), it is still very competitive and is even better than other algorithms. Unlike UMAC, however, the present invention's construction is interesting in its own right and can lend itself to other applications besides MACS. Through optimization, the present invention can improve the speed of its algorithm and reduce the amount of key utilized.

The present invention's methods also provide a model for checksumming. Detailed infra, it is shown that any two inputs that collide within a block must differ in at least two locations. The collision probability of the present invention's MAC is much smaller if the input differs in at least three locations. While this is not substantially helpful in an adversarial context, when utilizing the present invention's MAC as a checksum, it can provide such a guarantee. Generalizing this notion, a d-semi-universal hash is defined to be one where the collision probability of two inputs that differ in d locations is nearly that of colliding with an independently chosen element of the range. The present invention's algorithm is a 3-semi-universal hash and more efficient variants can be d-semi-universal for larger d.

In order to fully appreciate the present invention, several conventions are utilized as follows. Fix a modulus m=2^{l}, for example, l=32. A word refers to an element of [symbol] and a double word to an element of [symbol] Hence, words can be thought of as l bit integers and double words as 2l bit integers. All operations take place over words, that is, over [symbol] unless otherwise specified. The ability of modern processors to multiply two words to produce a double word in a single instruction is exploited; this operation is denoted as ×*. For x, y ε [symbol] x×*y is in [symbol] that is, the result is viewed as a two word vector. If necessary, the input is padded to consist of an integral number of words. For simplicity, an input consists of b blocks, each of which has a fixed block length of t words.

Typically data is processed by blocks. Thus, the present invention's construction is described for a map v that sends an input block X=x₁, . . . , xₜ into l-bit hash value v=v(X). The block key consists of l-bit words aᵢ, for 1≦i≦t; the same key is reused with each block. fᵢ: [symbol] is defined by fᵢ(x)=aᵢ×*x. The present invention's algorithm utilizes fixed public matrices A₁, . . . , Aₜ. These can contain very small entries so that matrix products can be implemented very efficiently by addition and subtraction of words.

Let vᵢ be the column vector of two words equal to fᵢ(xᵢ). Define matrices Bᵢ, B and B₀, which have the form

$$[ \begin{matrix}* & * & * \\ * & * & * \\ 0 & 0 & 1\end{matrix} ] ,$$

where

$${B}_{0} = [ \begin{matrix}1 & 0 & {z}_{0} \\ 0 & 1 & \\ 0 & 0 & 1\end{matrix} ] ,$$

and for i>0,

$${B}_{i} := [ \begin{matrix} {A}_{i} & & {v}_{i} \\ 0 \; 0 & & 1\end{matrix} ] , B := {B}_{0} \cdot {\prod }_{i = 1}^{t} {B}_{i} \text{=:} [ \begin{matrix} A & & z \\ 0 & 0 & 1\end{matrix} ] \qquad ( Eq . 1 )$$

It is clear that B can be written as above; z is the first two components of the third column of B and A has determinant ±1. z₀ is an initial value for the block. Also computed is:

$$σ = {σ}_{0} + {\sum }_{i = 1}^{t} {v}_{i} ,$$

where σ₀ is another initial value for the block. The hash value is v(X)=(z, σ).

Other instances of the present invention can be employed to provide inter-block chaining. For example, assume the k^{th} block is associated with two uniform hash functions F₁^{(k)} and F₂^{(k)} mapping double words to double words (the superscript is dropped if the block number is clear from the context). If (z′, σ′) is the output of a hashed block, this is chained to the next block by setting σ₀=F₂(σ′) and:

$${B}_{0} = [ \begin{matrix}1 & 0 & {F}_{1} ( {z}^{′} ) \\ 0 & 1 & \\ 0 & 0 & 1\end{matrix} ]$$

as the initial values for the next block. These inter-block functions can be repeated to save on key length, at some cost of security, which is detailed infra. The exact definition of these functions is not extremely important for these applications.

In other instances of the present invention, a hash value length can be doubled by performing an independent hash in parallel. Key words bᵢ, 1≦i≦t are utilized, which are independent of the aᵢ and set the functions gᵢ, i≦t, to g(x)=bᵢ×*x. uᵢ=gᵢ(xᵢ) is defined and, as above, gets a map X [symbol] H u(X) with the hash value u utilizing:

$${C}_{i} := [ \begin{matrix}{A}_{i} & & {u}_{i} \\ 0 & 0 & 1\end{matrix} ] , {C}_{0} := [ \begin{matrix}1 & 0 & {u}_{0} \\ 0 & 1 & \\ 0 & 0 & 1\end{matrix} ] , \\ C := {C}_{0} \cdot {\prod }_{i = 1}^{t} {C}_{i} \text{=:} [ \begin{matrix}A & w \\ 0 \; 0 & 1\end{matrix} ] . \qquad ( Eq . 2 )$$

Also computed is

$$v = {v}_{0} + {\sum }_{i = 1}^{t} {u}_{i} .$$

The overall hash is now:
(v(X), u(X))=(z, σ, w, v).

Thus, the present invention provides a lengthened transformation value or hash value with a collision probability that can be based on the following theorem.

Theorem 1: For t≦50, if H=(z, σ, w, v) and H′=(z′, σ′, w′, v′) are the hash values computed from two distinct inputs, then:
Pr[H=H′]≦2^{-4l+20},
where the probability is taken over the choice of key.
   This theorem follows directly from Lemmas 3 and 4 infra. It is noted that the theorem is not optimal, in that the choice for the matrices of Lemma 4 could be improved.

The analysis of the hash of a single block is focused upon first, and it is assumed that B_{0=I for a} 3×3 identity matrix. By repeated utilization of the identity:

$$[ \begin{matrix}A & v \\ 00 & 1\end{matrix} ] \cdot [ \begin{matrix}B & u \\ 00 & 1\end{matrix} ] = [ \begin{matrix}AB & Au + v \\ 00 & 1\end{matrix} ] ;$$

in Equation (1):
z=v₁+A₁v₂+A₁A₂v₃+ . . . +A₁A₂ . . . Aₜ₋₁vᵢ. (Eq. 3)
For two (not necessarily distinct) input blocks X and X′, X=x₁, . . . , xₜ and X′=x′₁, . . . . , x′ₜ is written and v′ᵢ=fᵢ(x′ᵢ) is defined. z′ and σ′ are defined analogously to z and σ.

The following technical lemma relating the distributive law of ×* over vector subtraction is needed. In general, it is not true that a×*x−a×*x′=a×* (x−x′), and, thus, the operation is not linear. However, assuming x≠x′, a×*x−a×*x′ is nearly as likely to collide with any fixed value as a×*(x−x′).

Lemma 1. Given any fixed words x≠x′ and any fixed double word α=(α₁, α₂),

$${Pr}_{a} [ {ax}_{*} x - {ax}_{*} {x}^{′} = α ] \leq {2}^{- ℓ + 2} ,$$

where the probability is taken over uniformly chosen odd words a ε

[symbol]

Proof: For this proof, let · denote the usual multiplication over double words. By abusing notation, a·x=y is written for a,x ε [symbol] and y ε [symbol] it is noted also in this case that there is no overflow, so that y=ax as integers. The crux of this lemma is the difference between subtraction over double words as integers modulo m² and subtraction over two-dimensional vectors modulo m. To make this distinction explicit, for an element x ε [symbol] [x] is written as the vector corresponding x, so that [x] ε [symbol] Then for double words y and z, if [y]−[z]=(w₁, w₂), then [y−z]=(w₁−c, w₂), where c is either 0 and 1 depending on whether there is a carry between the low and high words or not.

Let A be the set of all odd a that cause a collision, that is, for the fixed α=(α₁, α₂), all a such that [a·x]−[a·x′]=α for x and x′ as in the statement of the lemma. Then for any a ε A, [a·x−a·x′]=(α₁−cₐ, α₂), for cₐ=0 or 1. Given a, a′ ε A with cₐ=c_{a′}a·(x−x′)=a′·(x−x′) exists over the integers, so that as x≠x′, a=a′. Thus, A contains at most two elements, possibly one with carry 0 and possibly one with carry 1. As there are 2^{l-1} choices for odd a, the chance of choosing one in A is at most 2·2^{-l+1}=2^{-l+2}, as required.

The hash function proper is now analyzed.

Lemma 2: If (z, σ)=(z′, σ′) for distinct inputs X and X′, then X and X′ differ in at least two locations.

Proof: Suppose not, so that xᵢ=x′ᵢ for all i≠j, and xⱼ≠x′ⱼ for some j. Then σ−σ′=aⱼ×*xⱼ−aⱼ×*x′ⱼ. As aⱼ is odd and hence an invertible map from [symbol] σ≠σ′, contradicting (z, σ)=(z′, σ′).

It is now known that colliding inputs have at least two distinct words—however, which words these are, is not known. This is where computing the hash as a matrix product and sum helps. For example, if x and y are independently distributed over [symbol] then 2x+y and 2y−x are independently distributed as well. Note, however, that x+y and x−y are not independently distributed; for example, they have the same parity. The difference between these two examples is that the former arises from the matrix

$$[ \begin{matrix}2 & 1 \\ - 1 & 2\end{matrix} ] ,$$

which is invertible over [symbol] while the matrix of the latter is

$$[ \begin{matrix}1 & 1 \\ 1 & - 1\end{matrix} ]$$

has determinant −2, and so is not invertible over [symbol] The relationship between the two components of the present invention's hash pair, z and σ, is similar, so that if the present invention's matrices are picked carefully, z and σ are independent.

Definition 1: A sequence of matrices (A₁, . . . , Aₜ) is k-invertible if for any i<j, and Δ defined as:
Δ=det(Aᵢ . . . Aⱼ₋₁−1),
then Δ is nonzero, and if 2^{k′}|Δ, then k′≦k.

For any interval I=(i, j), the matrix B=Π_{I} Aᵢ−I of k-invertible Aᵢ is nearly invertible in the following sense. Let det(B)=s2^{k′} for odd, nonzero s and k′≦k. Then Bx=α can be solved modulo 2^{l-k} uniquely and then there are 2^{k} solutions modulo 2^{l}. Thus the value k should be as small as possible.

Lemma 3: Assume that (A₁, . . . , Aₜ) is k-invertible. Then for distinct inputs X≠X′, Pr_{{a}_{ᵢ}_{}}[(z, σ)=(z′, σ′)]≦2^{-2l+4+k}, where fᵢ(x)=aᵢ×*x.

Proof: Let δxᵢ=xᵢ−x′ᵢ and δvᵢ=f(xᵢ)−f(x′ᵢ)=aᵢ×*x′ᵢ. By the Lemma 2, it can be assumed that there exists i<j such that δxᵢ≠0 and δxⱼ≠0. The analysis is now in terms of matrix equations over [symbol] involving Aᵢ's and δvᵢ; the inputs xᵢ and x′ᵢ are involved implicitly in a non-linear way which will by Lemma 1 will cost a factor of 2. By fixing all aᵣ for r≠i,j:

$$\begin{matrix}{Pr}_{{a}_{i} , {a}_{j}} [ ( z , σ ) = ( {z}^{′} , {σ}^{′} ) ] \\ = {Pr}_{{a}_{i} , {a}_{j}} [ {A}_{1} … {A}_{i - 1} δ {v}_{i} + {A}_{1} … {A}_{j - 1} δ {v}_{j} \\ = α , δ {v}_{i} + δ {v}_{j} \\ = β ] ,\end{matrix} \qquad ( Eq . 4 )$$

for appropriate fixed α and β. Rearranging (Eq. 4) for some fixed α′, it is equivalent to:

$${Pr}_{{a}_{i} , {a}_{j}} [ ( {A}_{i} … {A}_{j - 1} - I ) δ {v}_{j} = {α}^{′} , δ {v}_{i} + δ {v}_{j} = β ] .$$

Let B=(Aᵢ. . . Aⱼ₋₁−I), and let Δ=det B. As (Aᵢ, . . . , Aⱼ₋₁) are k-invertible, Δ=s·2^{k′} for some odd s and k′≦k. As remarked above, Bδvⱼ=α′ iff 2^{k′}δvⱼ=α* in [symbol] for some fixed α* depending on α and B. As from Lemma 1 Prₐ_{ⱼ}[δvⱼ=γ]≦2^{-l+2} for any fixed γ, Prₐ_{ⱼ}[2^{k′}δvⱼ=α*]≦2^{-l+2+k′}≦2^{-l+2+k} (recall all operations are performed over [symbol] ).

Finally, if the event 2^{k}δvⱼ=α* occurs, then Prₐ_{ᵢ}[δvᵢ+δvⱼ=β]≦2^{-l+2}, as δvᵢ depends only on aᵢ, independently from vⱼ. Multiplying these probabilities gives the lemma.

The operation of the hash over several blocks is now considered. Let (zₖ, σₖ) be the output of the k^{th} block, so that the initial values for the k+1 block are F₁^{(k)}(zₖ) and F₂^{(k)}(σₖ). If the keys for the pair (F₁^{(k)}, F₂^{(k)}) are new at each block, then the initial positions at each block are independent, utilizing the uniformity of the Fᵢ. Given two messages X₁, . . . , Xₙ and X′₁, . . . , X′ₙ, let i be the largest index of different blocks, so that Xᵢ≠X′ᵢ and Xⱼ=X′ⱼ for j>i. Then H(X₁, . . . , Xₙ)=H(X′₁, . . . , X′ₙ) iff (zᵢ, σᵢ)=(z′ᵢ, σ′ᵢ). If H(X₁, . . . , Xᵢ₋₁)=H(X′₁, . . . , X′ᵢ₋₁), then the probability that (zᵢ, σᵢ)=(z′ᵢ, σ′ᵢ) is given in Lemma 3. Otherwise, by fixing all key bits but those for Fᵣ⁽ⁱ⁻¹⁾, r=1,2, the probability that (zᵢ, σᵢ)=(z′ᵢ, σ′ᵢ) is equal to that of a collision in the Fᵣ⁽ⁱ⁻¹⁾, which is smaller than that of Lemma 3. If it is desirable to save on key size, the Fⱼ⁽ⁱ⁾ can be reused. A standard union-bound shows that the bit-security of the hash decreases linearly with the frequency of reuse.

The choice of the sequence A₁, . . . , Aₜ can be tailored to implementation requirements. Obviously there is a trade-off between finding k-invertible matrices for minimum k while ensuring that the matrix-vector products of the hashing algorithm can be efficiently computed. The implementations described infra utilize the families below. It should be noted that if the order of the matrices is changed, the determinants of interest may be identically zero.

Lemma 4. Define the following integer matrices of determinant ±1.

$$\begin{matrix}{A}_{1}^{′} = ( \begin{matrix}- 1 & 1 \\ 1 & - 2\end{matrix} ) , \\ {A}_{2}^{′} = ( \begin{matrix}2 & 1 \\ 1 & 1\end{matrix} ) , and \\ {A}_{3}^{′} = ( \begin{matrix}1 & 3 \\ 1 & 2\end{matrix} ) .\end{matrix}$$

This is now extended periodically into a longer sequence: Aₜ=(A₁, . . . , Aₜ) where Aᵢ₊₃ₛ=A′ᵢ. Then A₁₉ is 4-invertible, and A₅₀ is 6-invertible.

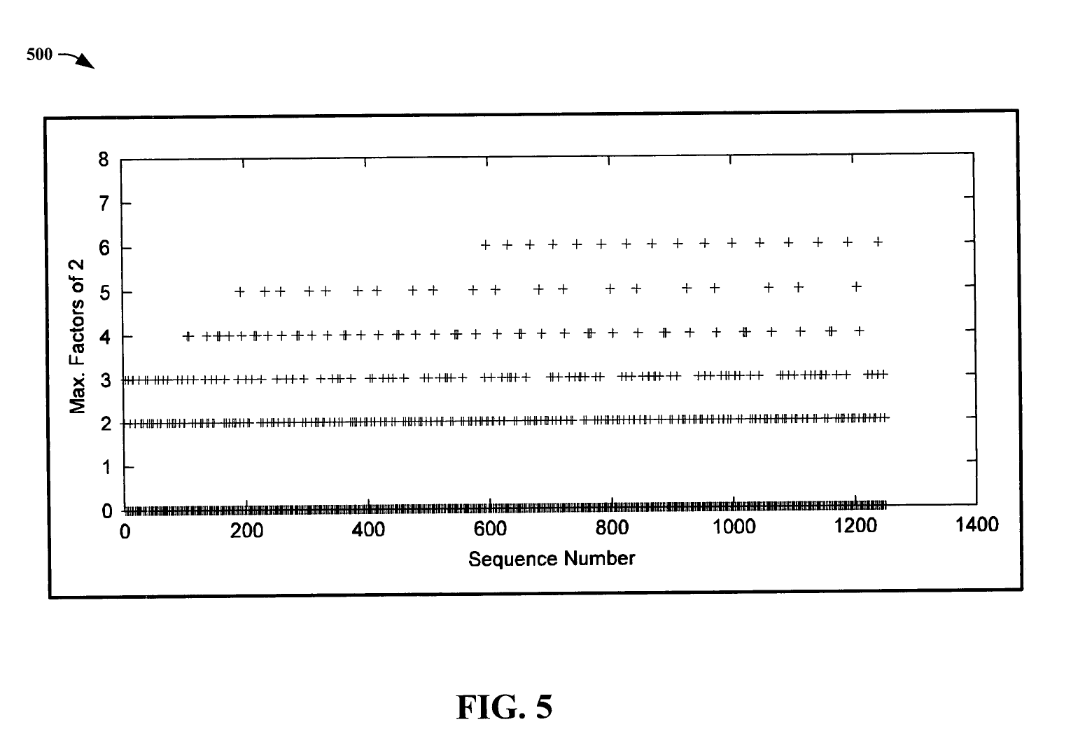

Proof: This can be verified by direct computation. A graph 500 of the k-invertibility of A₅₀ is shown in FIG. 5. The y-axis is the largest k≧0 such that 2^{k}|det((Πᵢ^{j}Aₛ)−I), where the interval {i . . . j} is given by the sequence number. The determinant is nonzero in all cases. Further exploitation of the noticeable structure in the graph 500 is possible.

Another family of matrices is now considered whose near-invertibility is not as good. However, these matrices have entries from {±1, 0}, yielding more efficient implementations. Some implementations of instances of the present invention suggest a 15% speed-up when utilizing these simpler matrices. It can also be shown that the determinants of interest are non-zero, if not nearly odd.

Lemma 5. Define the following matrices.

$$\begin{matrix}{B}_{1}^{′} = ( \begin{matrix}1 & 1 \\ 1 & 0\end{matrix} ) , \\ {B}_{2}^{′} = ( \begin{matrix}- 1 & - 1 \\ 0 & - 1\end{matrix} ) , \\ {B}_{3}^{′} = ( \begin{matrix}0 & 1 \\ 1 & 1\end{matrix} ) , and \\ {B}_{4}^{′} = ( \begin{matrix}- 1 & 0 \\ - 1 & - 1\end{matrix} ) .\end{matrix}$$

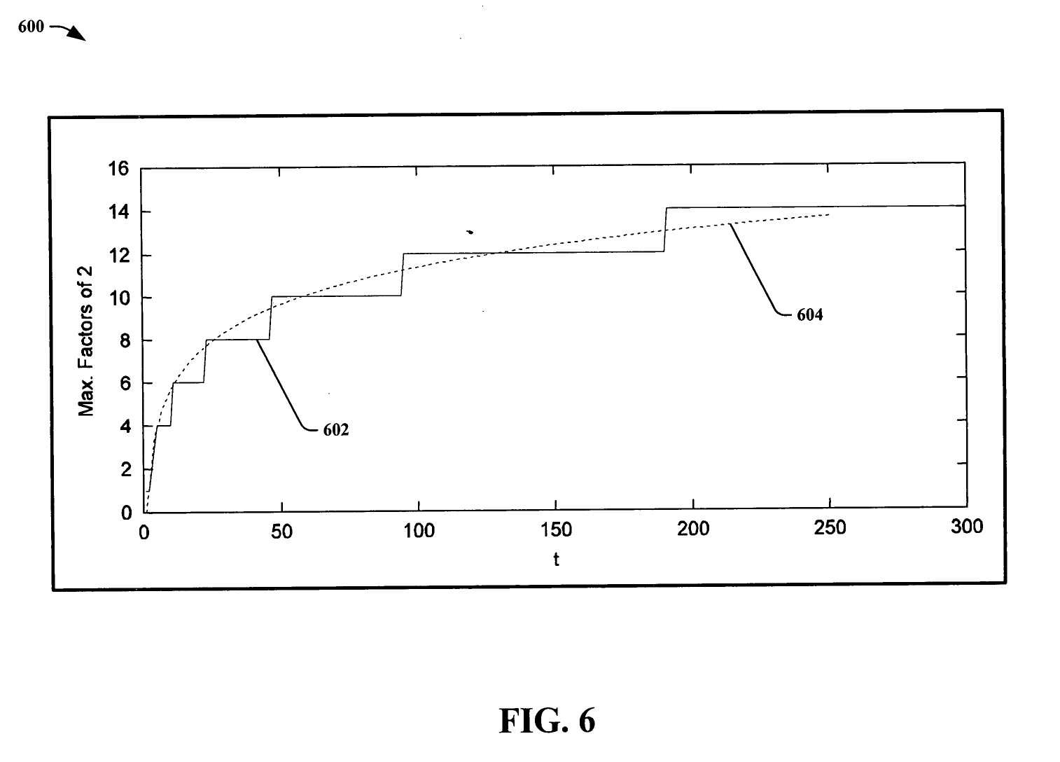

Set Bᵢ=B′_{(i mod 4)+1} and Bₜ=(B₁, . . . , Bₜ). Then for any 1≦i≦j≦t, if M=Πᵢ^{j} Bₛ, det(M−I)≠0.
   This is a necessary condition for k-invertibility, though clearly it is insufficient in general. Experimentally, Bₜ is roughly log_{1.5} t-invertible. For t˜50, they are not as invertible as A₅₀, so some instances of the present invention have not utilized them. FIG. 6 is a graph 600 illustrating the k-invertibility of Bₜ versus the log_{1.5} t as t is increased. The k-invertibility of Bₜ (solid line 602) plotted against log_{1.5} t (dashed line 604). Here the y-axis is the largest k such that 2^{k}|det((Πᵢ^{j} Bₛ)−I), for all 1≦i≦j≦t, for the specified t.

Proof: For a matrix A, A≧0 if each entry of A is at least 0. A≦0 if −A≧0 and A≧A′ if A−A′≧0. |A| denotes the matrix whose entries are the absolute value of those of A.

In the notation of Lemma 5, note that:

$$\begin{matrix}{X}_{1} = {B}_{1}^{′} {B}_{2}^{′} \\ = {B}_{2}^{′} {B}_{3}^{′} \\ = ( \begin{matrix}- 1 & - 2 \\ - 1 & - 1\end{matrix} ) and \\ {X}_{2} = {B}_{3}^{′} {B}_{4}^{′} \\ = {B}_{4}^{′} {B}_{1}^{′} \\ = ( \begin{matrix}- 1 & - 1 \\ - 2 & - 1\end{matrix} ) .\end{matrix}$$

By examination, for all 1≦s≦4, det(B′ₛ−I)ε{−1,4} and hence nonzero, and Tr(B′ₛ)ε{1,−1} and is at least 1 in absolute value. For r=1,2, det(Xᵣ−I)=2≠0 and Tr(Xᵣ)=−2. Finally, det (B′ₛXᵣ−I)ε{−4,−3,6}. Hence, the analysis can proceed by induction and assume j−i>2. Set

$${M}^{′} = {\prod }_{s = i}^{j - 2} {B}_{s}$$

and fix r so that M=M′ Xᵣ, and, by induction, it can be assumed that |Tr(M′)|≧2.

Since det(M)=±1, det(M−I)=det(M)+1−Tr(M), and det(M)+1=0 or 2, it will be enough to show that |Tr(M)|>2. Note that M≧0 or M≦0, for Bₛ=±1·|Bₛ|, so that M=±1·Πᵢ^{j}|Bₛ|, and Π|Bₛ|≧0. As M′≧0 or M′≦0, utilizing the same argument as for M, by examining Xᵣ, it can be seen that |M|≧|M′|.

One can label the off-diagonal elements of M′ by x and y, so that
Tr(M)=Tr(M′Xᵣ)=−(|Tr(M′)|+2|x|+|y|),
if necessary by exchanging x and y. In a similar way as showing |M|≧|M′|, one can show |M′|>0, so thus |Tr(M)|≧|Tr(M′)|+1≧3, utilizing the inductive assumption on M′. Hence det(M−I)≠0, as required.

The present invention's hash methods can be adjusted to account for operating constraints of modern processors. In particular, instances of the present invention incorporate parallelization which is useful in processors that have SIMD operations. For example, the MMX™ brand type instruction set standard on Intel Pentium II™ brand and later processors can operate simultaneously on 32-bit words with a throughput of 2 per cycle. For brevity, a hash or MAC has s bits of security if the collision probability (over the choice of keys) on two distinct fixed messages is ≦2^{-s}. Utilizing A₅₀, by Lemma 3 each hash gives 2·32−4−6=54 bits of security, utilizing 30 32-bit words of key per MAC per stream, plus the key for the inter-block chaining. As two MACS are computed, the total security is 108 bits. Utilizing MMX™ brand type instructions on a 1.06 GHz Celeron™ brand type processor, this MAC was computed at a peak rate of 3.7 cycles per byte. An instance of the present invention can be implemented utilizing an optimized SSE2™ brand type algorithm. Performance of this instance of the present invention depends on the context of its utilization. Other instances of the present invention have implemented a hash utilizing a single stream, which gives 54 bits of security. This achieved a peak rate of 2.0 cycles per byte.

The present invention's methods are also competitive with UMAC on the length of a generated key. To maintain the security bounds of Lemma 3, each inter-block hash needs four 32-bit words of key per hash stream. Each of the present invention's blocks then requires 50·2 32-bit words of key. Thus, for an 8 Kbyte message, 42 inter-block hashes are required, for 5376 bits of key per hash stream. The total for an 8 Kbyte message and two hash streams is 13.6 Kbits of key. This compares with the UMAC implementation (see, J. Black, S. Halevi, H. Krawczyk, T. Krovetz, and P. Rogaway; UMAC home page, 2000; URL: http://www.cs.ucdavis.edu/˜rogaway/umac) which requires 8 Kbits of generated key to hash a message of any length to 60 bits of security.

This information is summarized with context from other algorithms in Table 1, where “P.I.” denotes an instance of the present invention. Data for other algorithms was taken from (Black, Halevi, Krawczyk, Krovetz, and Rogaway, 1999) and (Black, Halevi, Krawczyk, Krovetz, and Rogaway, 2000).

TABLE 1
MAC COMPARISONS

| | Security | Peak Rate | Key Size | |
|---|---|---|---|---|
| Algorithm | (Bits) | (cycles/byte) | (8 Kbyte Message) | |
| P.I. (two streams) | 108 | 3.7 | 13.6 | Kbits |
| P.I. (one stream) | 54 | 2.0 | 6.8 | Kbits |
| UMAC | 60 | 0.98 | 8 | Kbits |
| SHA-1 | 80 | 12.6 | 512 | bits |

The proof k-invertibility of the present invention's matrix sequences is computational. However, it is not necessary for such sequences to be periodic. More complex families can improve the speed and the security of the present invention's hash. For example, a periodic sequence of 4×4 matrices of length 80 which is 4-invertible exists. The larger matrices can be utilized to consume twice as much input per iteration, and the longer sequence length means the inter-block chaining is less frequent, improving efficiency. Instances of the present invention with these implementations show this is 17% faster than the matrices of Lemma 4, and 2% faster than the matrices of Lemma 5, while providing more security than the other sequences.

Both the present invention's construction and UMAC benefit from the media processing instructions found on Pentium™ brand CPUs. Other platforms, such as those of AMD brand, or Intel's Itanium™ brand CPUs, have different advantages, including larger register files. These details can be exploited by the present invention to increase the relative performance between the present invention's MAC and UMAC.

Since the present invention's operations are invertible, they can be combined with authentication and encryption with stream ciphers. The idea is rather simple: utilize the final hash value to define a key for a stream cipher to generate a one-time pad. Instead of encrypting the input sequence xᵢ, one encrypts yᵢ=aᵢxᵢ+bᵢ, where aᵢ and bᵢ are random key words (the first quantity is the lower half of a vᵢ in a step of the present invention's MAC). As before, the hash value needs to be further encrypted. One needs to exercise caution here: if addition to bᵢ were omitted, one can still observe correlations. This would be the case if the inputs xᵢ end in many zeroes and RC4 is utilized (see, J. Golic; Linear Statistical Weaknesses in Alleged RC4 Keystream Generator; In Advances in Cryptology—EUROCRYPT '97, volume 1233 of Lecture Notes in Computer Science, pages 226-238; Springer-Verlag, 1997 and Ilya Mironov; Not So Random Shuffles of RC4; In Advances in Cryptology—CRYPTO 2002, Lecture Notes in Computer Science. Springer-Verlag, 2002). Masking of correlations in RC4 could yield improvements in the present invention.

The inter-block chaining can be further optimized by exploiting existing slack in the utilization of key. Almost twice as much key is utilized in inter-block hashing as is utilized for the blocks. Key reuse techniques such as a Toplitz shift (see, Black, Halevi, Krawczyk, Krovetz, and Rogaway, 1999) could address this problem. The utilization of a single pairwise independent hash could be sufficient.

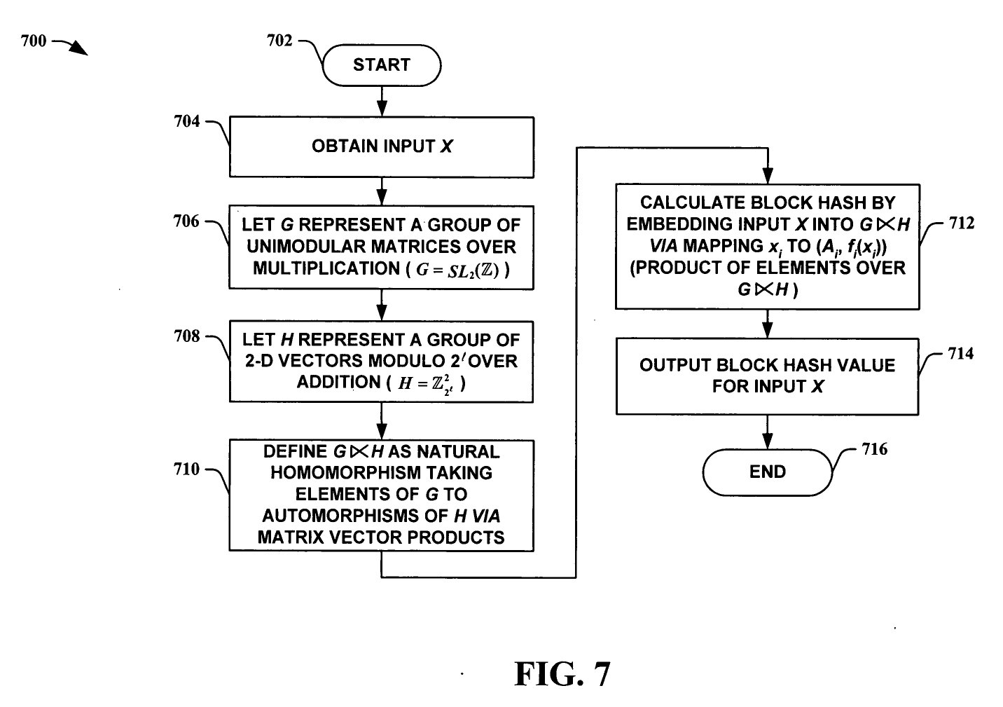

In view of the exemplary systems shown and described above, methodologies that may be implemented in accordance with the present invention will be better appreciated with reference to the flow charts of FIGS. 7-12. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

The invention may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the present invention.

The present invention's construction can be viewed in a general manner. In FIG. 7, a flow diagram of a method 700 of facilitating data transformation in accordance with an aspect of the present invention is shown. The method 700 starts 702 by obtaining input data X, where X=x₁, . . . , xₜ 704. Let G represent a group of unimodular matrices over multiplication (G=SL₂ [symbol] ) 706. Let H represent a group of 2-dimensional vectors modulo 2^{l} over addition [symbol] 708. Define G [symbol] H as the natural homomorphism taking elements of G to automorphisms of H via matrix vector products 710. Input data X is then embedded into G [symbol] H via mapping xᵢ to (Aᵢ, fᵢ(xᵢ)) (product of elements over G [symbol] H) to calculate the block hash, where Aᵢ is a 2×2 matrix with det(Aᵢ)=±1 and 1≦i≦t 712. The block hash value is then output for input data X 714, ending the flow 716. Given an appropriate transformation function, fᵢ, the present invention's construction can also be generalized to larger matrices.

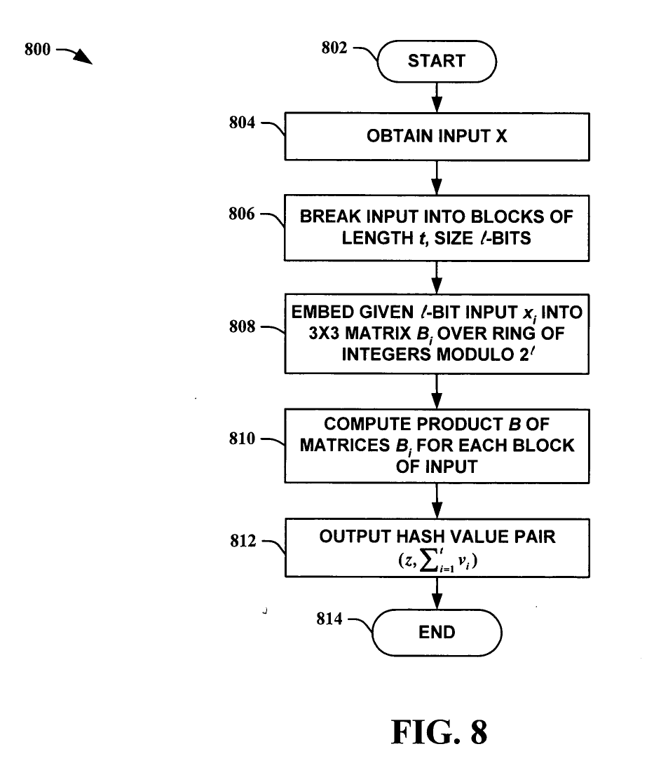

Referring to FIG. 8, another flow diagram of a method 800 of facilitating data transformation in accordance with an aspect of the present invention is depicted. The method 800 starts 802 by obtaining input data X, where X=x₁, . . . , xₜ 804. Input data X is then broken down into blocks of length t words, each of size l-bits 806. A given l-bit input xᵢ is then embedded into a 3×3 matrix Bᵢ over the ring of integers modulo 2^{l} by xᵢ

$${x}_{i} ↦ [ \begin{matrix}{A}_{i} & {v}_{i} \\ 00 & 1\end{matrix} ] = \text{:} {B}_{i} ,$$

where vᵢ=fᵢ(xᵢ) is a vector with two elements, Aᵢ is a 2×2 matrix with det(Aᵢ)=±1, and 1≦i≦t 808. Here the sequence of Aᵢ's is fixed independent of the input xᵢ. The Aᵢ sequence utilized by this instance of the present invention is periodic, so that the implementation can be unrolled and have a small code footprint. The function, fᵢ(x), is defined by multiplication with random odd aᵢ, where aᵢ and x are l bits, and the 2l bit result is viewed as a vector of two l-bit numbers. Thus, fᵢ(x) is invertible modulo 2^{2l} and can be implemented in one instruction utilizing a 2l-bit result of multiplication of two l-bit quantities. For each block of input data X, the product

$$B = [ \begin{matrix}A & z \\ 00 & 1\end{matrix} ]$$

of these matrices Bᵢ is then computed 810. The present invention then outputs a hash value pair

$$( z , {\sum }_{i = 1}^{t} {v}_{i} )$$

812, ending the flow 814. The collision probability is substantially near 2^{-2l} by utilizing the invertibility of Aᵢ and the arithmetic properties of the determinants of the matrices of the form

$${\prod }_{i = j}^{k} {A}_{i} - I$$

over [symbol] (and not modulo 2^{l}). The present invention offers simplicity and can facilitate other applications besides MAC applications.

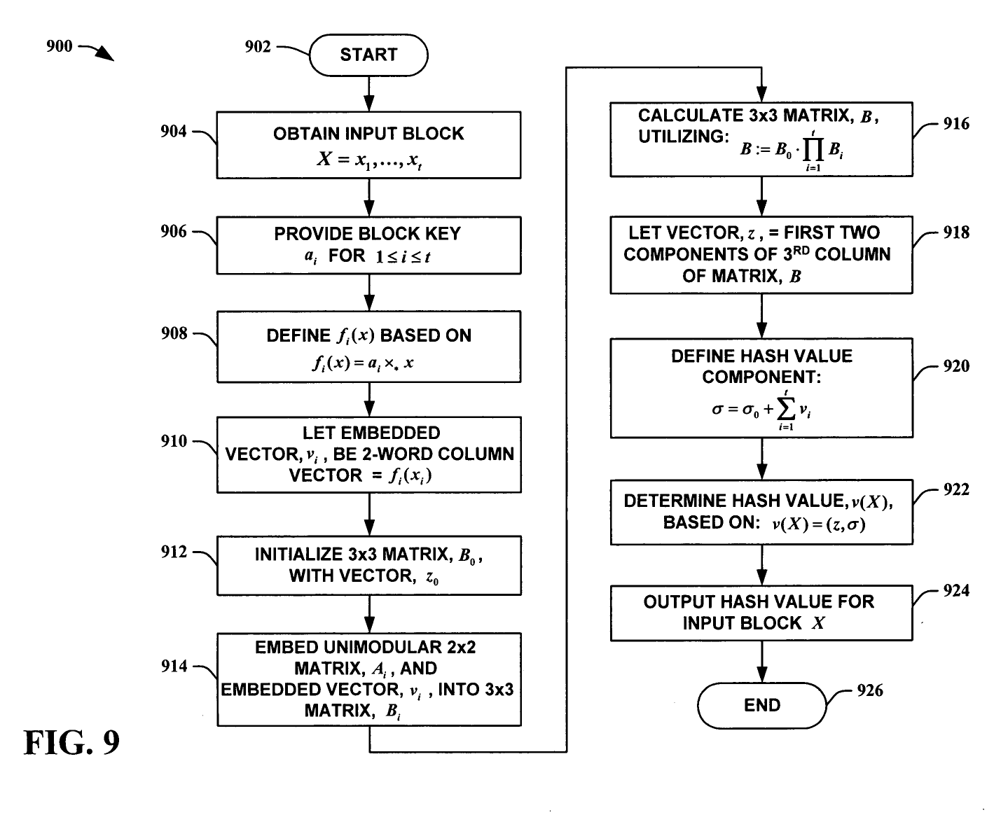

Turning to FIG. 9, yet another flow diagram of a method 900 of facilitating data transformation in accordance with an aspect of the present invention is illustrated. Typically data is processed by blocks. Thus, this instance of the present invention's construction is described for a map, v, that sends an input data block X=x₁, . . . , xₜ into l-bit hash value v=v(X). The method 900 starts 902 by obtaining input data block X, where X=x₁, . . . , xₜ 904. A block key is then provided 906. The block key consists of l-bit words aᵢ, for 1≦i≦t; the same key is reused with each block. fᵢ: [symbol] is then defined by fᵢ(x)=aᵢ×*x 908. This instance of the present invention's algorithm utilizes fixed public matrices A₁, . . . , Aₜ. These can contain very small entries so that matrix products can be implemented very efficiently by addition and subtraction of words. Let embedded vector, vᵢ, be a column vector of two words equal to fᵢ(xᵢ) 910. Initialize 3×3 matrix, B₀, with vector, z₀, such that

$${B}_{0} = [ \begin{matrix}1 & 0 & \\ & & {z}_{0} \\ 0 & 1 & \\ 0 & 0 & 1\end{matrix} ]$$

912. Embed a unimodular 2×2 matrix, Aᵢ, and the embedded vector, vᵢ, into a 3×3 matrix, Bᵢ such that

$${B}_{i} := [ \begin{matrix}{A}_{i} & {v}_{i} \\ 00 & 1\end{matrix} ]$$

914. Calculate a 3×3 matrix, B, utilizing

$$B := {B}_{0} \cdot {\prod }_{i = 1}^{t} {B}_{i}$$

916. This provides a matrix in the form of

$$B := [ \begin{matrix}A & z \\ 00 & 1\end{matrix} ] ,$$

where A has determinant ±1. Let vector, z, be defined as the first two components of the third column of matrix, B 918. Define a hash value component, σ, by

$$σ = {σ}_{0} + {\sum }_{i = 1}^{t} {v}_{i} ,$$

where σ₀ is an initial value for the input data block X 920. Determine a hash value, v(X), utilizing v(X)=(z, σ) 922. Output the hash value for the input data block X 924, ending the flow 926.

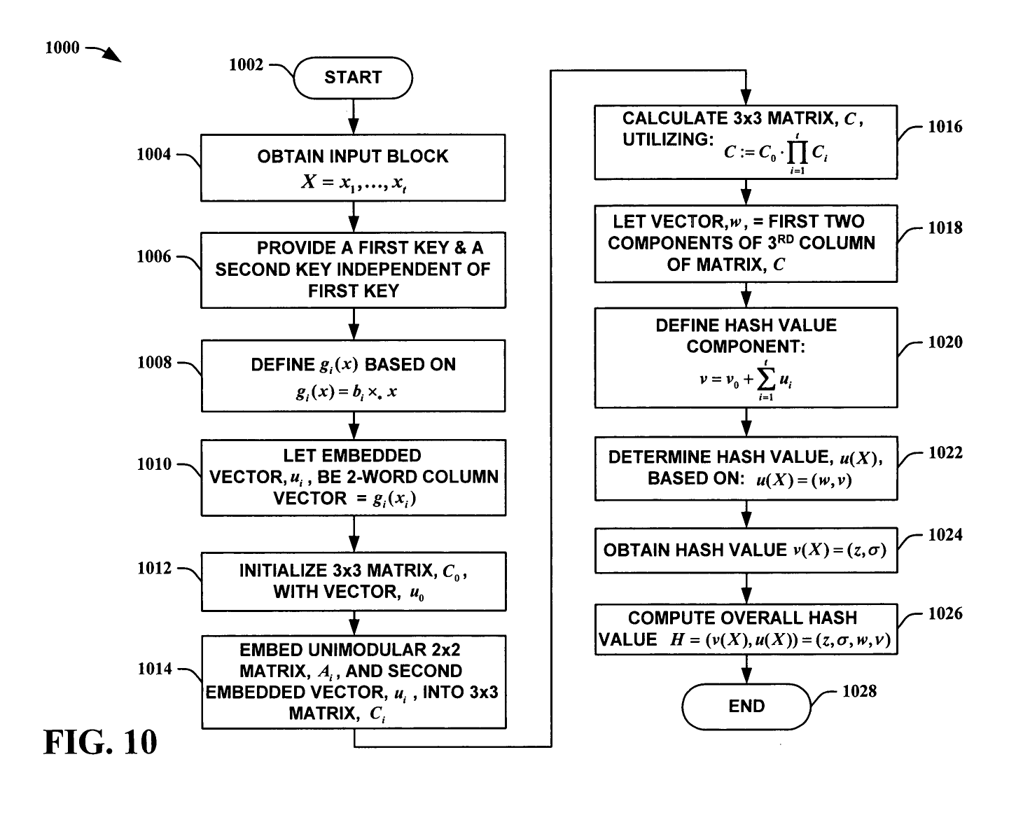

Moving on to FIG. 10, a flow diagram of a method 1000 of facilitating a data transformation value length in accordance with an aspect of the present invention is shown. In this instance of the present invention, a hash value length is doubled by performing an independent hash in parallel. The method 1000 starts 1002 by obtaining input data block X, where X=x₁, . . . , xₜ 1004. A first block key, aᵢ, and a second block key, bᵢ, which is independent of the first block key, is then provided 1006, where 1≦i≦t. Define gᵢ, i≦t, to g(x)=bᵢ×*x 1008. Let embedded vector, uᵢ, be a 2-word column vector, uᵢ=gᵢ(xᵢ) 1010. Initialize 3×3 matrix, C₀, with vector, u₀, such that

$${C}_{0} = [ \begin{matrix}1 & 0 & \\ 0 & 1 & {u}_{0} \\ 0 & 0 & 1\end{matrix} ]$$

1012. Embed a unimodular 2×2 matrix, Aᵢ, and the embedded vector, uᵢ, into a 3×3 matrix, Cᵢ such that

$${C}_{i} := [ \begin{matrix}{A}_{i} & & {u}_{i} \\ 0 & 0 & 1\end{matrix} ]$$

1014. Calculate a 3×3 matrix, C, utilizing

$$C := {C}_{0} \cdot {\prod }_{i = 1}^{t} {C}_{i}$$

1016. This provides a matrix in the form of

$$C := [ \begin{matrix}A & & w \\ 0 & 0 & 1\end{matrix} ] ,$$

where A has determinant ±1. Let vector, w, be defined as the first two components of the third column of matrix, C 1018. Define a hash value component, v, by

$$v = {v}_{0} + {\sum }_{i = 1}^{t} {u}_{i}$$

1020, where v₀ is an initial value for the input data block X. Determine a first hash value, u(X), utilizing u(X)=(w, v) 1022. Obtain a second hash value v(X)=(z, σ) via an instance of the present invention 1024 such as, for example, 20 the method described supra for FIG. 9. Compute an overall hash value, H, utilizing H=(v(X), u(X))=(z, σ, w, v) hash value for the input data block X 1026, ending the flow 1028. For t≦50, if H=(z, σ, w, v) and H′=(z′, σ′, w′, v′) are the hash values computed from two distinct inputs, then the collision probability of the present invention is Pr[H=H′]≦2^{-4l+20}, where the probability is taken over the choice of key.

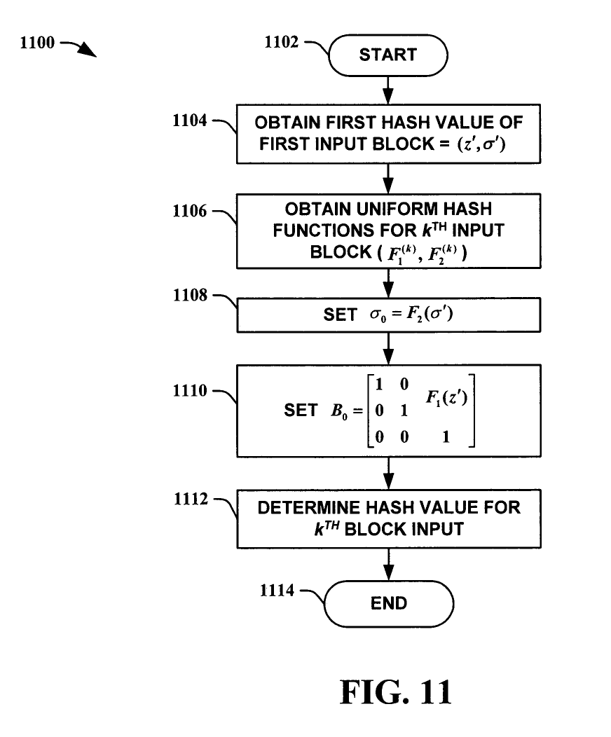

In FIG. 11, a flow diagram of a method 1100 of facilitating inter-block chaining for a data transformation in accordance with an aspect of the present invention is illustrated. The method 1100 starts 1102 by obtaining a first hash value, v′(X)=(z′, σ′), for an input block X 1104. Uniform hash functions such as, for example, F₁^{(k)} and F₂^{(k)}, are then obtained for a k^{th} input data block 1106. The input data block X hash value is then chained to the k^{th} input data block by setting σ₀=F₂(σ′) 1108 and

$${B}_{0} = [ \begin{matrix}1 & 0 & \\ 0 & 1 & {F}_{1} ( {z}^{′} ) \\ 0 & 0 & 1\end{matrix} ]$$

1110 for the k^{th} input data block. A hash value for the k^{th} input data block is then determined 1112, ending the flow 1114. The hash value for the k^{th} input data block can then be utilized to chain a subsequent block and so forth. These inter-block functions can be repeated to save on key length, at some cost of security. The inter-block chaining can be further optimized by exploiting existing slack in the utilization of key. Almost twice as much key is utilized in inter-block hashing as is utilized for the blocks. Key reuse techniques such as a Toplitz shift (see, Black, Halevi, Krawczyk, Krovetz, and Rogaway, 1999) could address this aspect. The utilization of a single pairwise independent hash could be sufficient.

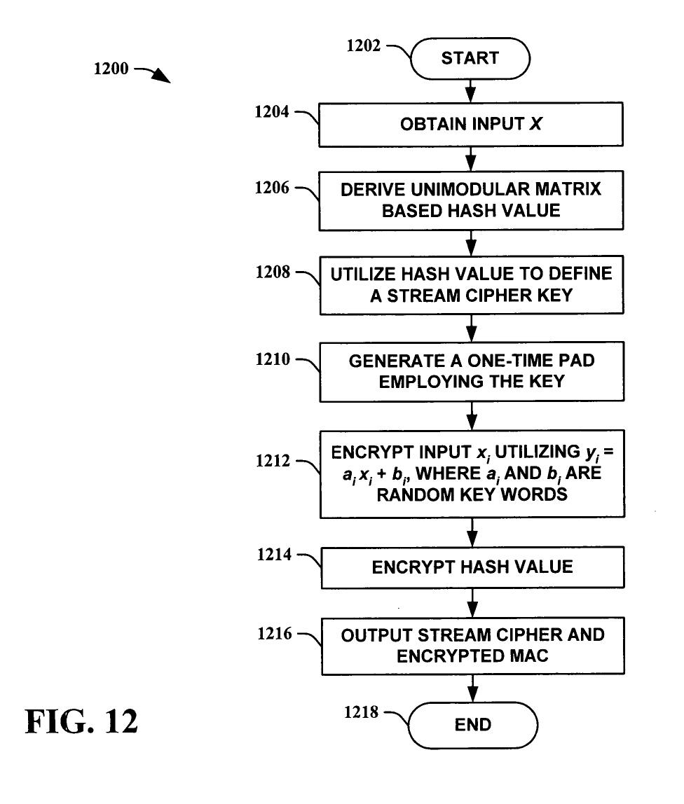

Looking at FIG. 12, a flow diagram of a method 1200 of facilitating data encryption in accordance with an aspect of the present invention is depicted. Since the present invention's operations are invertible, they can be combined with authentication and encryption with stream ciphers. The method 1200 starts 1202 by obtaining input data block X, where X=x₁, . . . , xₜ 1204. Derive a unimodular matrix-based hash value per the present invention 1206. Utilize at least a portion of hash value data employed during determination of the hash value to facilitate in defining a stream cipher key 1208. Generate a one-time pad employing the stream cipher key 1210. Encrypt input data block component xᵢ(1≦i≦t) with function, yᵢ, defined by yᵢ=aᵢxᵢ+bᵢ, where aᵢ and bᵢ are random key words and aᵢ is provided by the hash value data 1212. The hash value is then encrypted 1214. In other instances of the present invention, the hash value is not required to be encrypted and in still other instances of the present invention, the hash value data is only employed as a seed to a cipher process. The stream cipher and encrypted hash value (MAC) is then output 1216, ending the flow 1218. Typically, MACS are appended to the data that they represent before the combined data is transmitted.

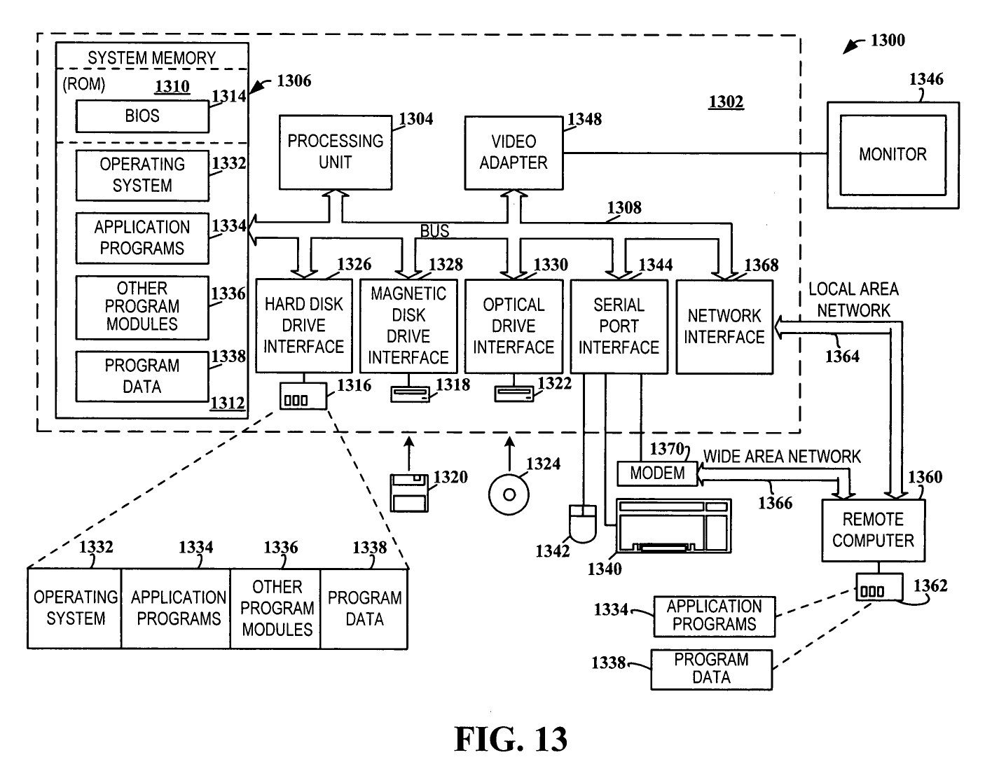

In order to provide additional context for implementing various aspects of the present invention, FIG. 13 and the following discussion is intended to provide a brief, general description of a suitable computing environment 1300 in which the various aspects of the present invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

With reference to FIG. 13, an exemplary system environment 1300 for implementing the various aspects of the invention includes a conventional computer 1302, including a processing unit 1304, a system memory 1306, and a system bus 1308 that couples various system components, including the system memory, to the processing unit 1304. The processing unit 1304 may be any commercially available or proprietary processor. In addition, the processing unit may be implemented as multi-processor formed of more than one processor, such as may be connected in parallel.

The system bus 1308 may be any of several types of bus structure including a memory bus or memory controller, a peripheral bus, and a local bus using any of a variety of conventional bus architectures such as PCI, VESA, Microchannel, ISA, and EISA, to name a few. The system memory 1306 includes read only memory (ROM) 1310 and random access memory (RAM) 1312. A basic input/output system (BIOS) 1314, containing the basic routines that help to transfer information between elements within the computer 1302, such as during start-up, is stored in ROM 1310.

The computer 1302 also may include, for example, a hard disk drive 1316, a magnetic disk drive 1318, e.g., to read from or write to a removable disk 1320, and an optical disk drive 1322, e.g., for reading from or writing to a CD-ROM disk 1324 or other optical media. The hard disk drive 1316, magnetic disk drive 1318, and optical disk drive 1322 are connected to the system bus 1308 by a hard disk drive interface 1326, a magnetic disk drive interface 1328, and an optical drive interface 1330, respectively. The drives 1316-1322 and their associated computer-readable media provide nonvolatile storage of data, data structures, computer-executable instructions, etc. for the computer 1302. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 1300, and further that any such media may contain computer-executable instructions for performing the methods of the present invention.

A number of program modules may be stored in the drives 1316-1322 and RAM 1312, including an operating system 1332, one or more application programs 1334, other program modules 1336, and program data 1338. The operating system 1332 may be any suitable operating system or combination of operating systems. By way of example, the application programs 1334 and program modules 1336 can include a data transformation scheme in accordance with an aspect of the present invention.

A user can enter commands and information into the computer 1302 through one or more user input devices, such as a keyboard 1340 and a pointing device (e.g., a mouse 1342). Other input devices (not shown) may include a microphone, ajoystick, a game pad, a satellite dish, a wireless remote, a scanner, or the like. These and other input devices are often connected to the processing unit 1304 through a serial port interface 1344 that is coupled to the system bus 1308, but may be connected by other interfaces, such as a parallel port, a game port or a universal serial bus (USB). A monitor 1346 or other type of display device is also connected to the system bus 1308 via an interface, such as a video adapter 1348. In addition to the monitor 1346, the computer 1302 may include other peripheral output devices (not shown), such as speakers, printers, etc.

It is to be appreciated that the computer 1302 can operate in a networked environment using logical connections to one or more remote computers 1360. The remote computer 1360 may be a workstation, a server computer, a router, a peer device or other common network node, and typically includes many or all of the elements described relative to the computer 1302, although, for purposes of brevity, only a memory storage device 1362 is illustrated in FIG. 13. The logical connections depicted in FIG. 13 can include a local area network (LAN) 1364 and a wide area network (WAN) 1366. Such networking environments are commonplace in offices, enterprise-wide computer networks, intranets and the Internet.

When used in a LAN networking environment, for example, the computer 1302 is connected to the local network 1364 through a network interface or adapter 1368. When used in a WAN networking environment, the computer 1302 typically includes a modem (e.g., telephone, DSL, cable, etc.) 1370, or is connected to a communications server on the LAN, or has other means for establishing communications over the WAN 1366, such as the Internet. The modem 1370, which can be internal or external relative to the computer 1302, is connected to the system bus 1308 via the serial port interface 1344. In a networked environment, program modules (including application programs 1334) and/or program data 1338 can be stored in the remote memory storage device 1362. It will be appreciated that the network connections shown are exemplary, and other means (e.g., wired or wireless) of establishing a communications link between the computers 1302 and 1360 can be used when carrying out an aspect of the present invention.

In accordance with the practices of persons skilled in the art of computer programming, the present invention has been described with reference to acts and symbolic representations of operations that are performed by a computer, such as the computer 1302 or remote computer 1360, unless otherwise indicated. Such acts and operations are sometimes referred to as being computer-executed. It will be appreciated that the acts and symbolically represented operations include the manipulation by the processing unit 1304 of electrical signals representing data bits which causes a resulting transformation or reduction of the electrical signal representation, and the maintenance of F data bits at memory locations in the memory system (including the system memory 1306, hard drive 1316, floppy disks 1320, CD-ROM 1324, and remote memory 1362) to thereby reconfigure or otherwise alter the computer system's operation, as well as other processing of signals. The memory locations where such data bits are maintained are physical locations that have particular electrical, magnetic, or optical properties corresponding to the data bits.

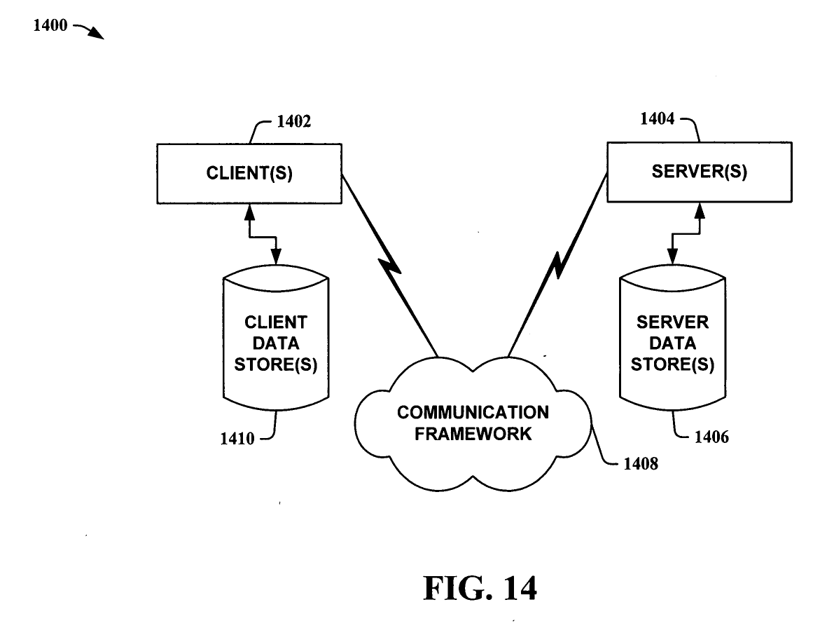

FIG. 14 is another block diagram of a sample computing environment 1400 with which the present invention can interact. The system 1400 further illustrates a system that includes one or more client(s) 1402. The client(s) 1402 can be hardware and/or software (e.g., threads, processes, computing devices). The system 1400 also includes one or more server(s) 1404. The server(s) 1404 can also be hardware and/or software (e.g., threads, processes, computing devices). The server(s) 1404 can house threads to perform transformations by employing the present invention, for example. One possible communication between a client 1402 and a server 1404 may be in the form of a data packet adapted to be transmitted between two or more computer processes. The system 1400 includes a communication framework 1408 that can be employed to facilitate communications between the client(s) 1402 and the server(s) 1404. The client(s) 1402 are connected to one or more client data store(s) 1410 that can be employed to store information local to the client(s) 1402. Similarly, the server(s) 1404 are connected to one or more server data store(s) 1406 that can be employed to store information local to the server(s) 1404.

In one instance of the present invention, a data packet transmitted between two or more computer components that facilitates data protection is comprised of, at least in part, information relating to a data transformation system that utilizes, at least in part, at least one unimodular matrix to provide a transformation value for input data to facilitate in protection of the input data.

It is to be appreciated that the systems and/or methods of the present invention can be utilized in data protection transformation facilitating computer components and non-computer related components alike. Further, those skilled in the art will recognize that the systems and/or methods of the present invention are employable in a vast array of electronic related technologies, including, but not limited to, computers, servers and/or handheld electronic devices, and the like.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A puzzle apparatus comprising:
(a) a first plurality of removable puzzle pieces that form a first picture when properly combined together that includes at least one visual representation associated with at least one audible sound producing means;
(b) at least a first detectible means associated with at least one of said puzzle pieces;
(c) a platform having a surface on which said puzzle pieces can be arranged and said at least one audible sound producing means;
(d) detection means associated with said platform and adapted for sensing said at least one detectible means, and providing a first output signal that is representative of said first plurality of puzzle pieces; and
(e) means actuable by a user for receiving said first output signal and activating said at least one sound producing means to produce a first audible sound associated with said at least one visual representation.

2. The puzzle apparatus as described in claim 1, wherein said apparatus further comprises:
(a) a second plurality of puzzle pieces that form a second picture when properly combined together that includes at least one visual representation associated with at least a second audible sound producing means;
(b) at least a second detectible means associated with at least one of said second plurality of puzzle pieces;
(c) said detection means is associated with said platform and is adapted for sensing said second detectible means and providing a second output signal that is representative of said second plurality of puzzle pieces; and
(d) said sound means when actuated by a user is adapted for receiving said second output signal and activating said second audible sound producing means for producing a second audible sound associated with said at least one visual representation of said second picture.

3. The puzzle apparatus as described in claim 1, wherein said first picture includes a visual representation associated with a plurality of audible sound producing means and said sound means includes a plurality of actuating means.

4. The puzzle apparatus as described in claim 2, wherein said first and second plurality of puzzle pieces respectively include a plurality of said detectible means.

5. The puzzle apparatus as described in claim 2, wherein each of said first and second pictures contain a plurality of visual representations associated with a plurality of audible sound producing means.

6. The puzzle apparatus as described in claim 2, wherein said platform is part of a housing in which electronic circuitry for said apparatus is contained.

7. The puzzle apparatus as described in claim 4, wherein said apparatus can sense the particular puzzle arranged on said platform and will provide different audible sounds for each of said puzzles

8. The puzzle apparatus as described in claim 7, wherein said sound means comprises:
(a) a plurality of actuators designed to be individually actuated by a user as desired;
(b) electronic circuitry for producing output signals corresponding to said audible sound producing means; and
(c) means for receiving said electronic signals and producing audible sounds corresponding to such signals.

9. The puzzle apparatus as described in claim 8, wherein said first and second plurality of puzzle pieces each include a plurality of visual representations associated with said audible sound producing means and said sound means is adapted to produce specific audible sounds associated with each of said visual representations.

10. The puzzle apparatus as described in claim 9, wherein said detection means is adapted to provide output signals to said sound means to indicate the type of puzzle arranged on said platform.

11. The puzzle apparatus as described in claim 9, wherein each of said actuators is associated with one of the plurality of representations of said audible sound producing means so that when a particular one of said actuators is activated by a user, the sound means will produce the specified audible sounds representative of said audible sound producing means.

12. The puzzle apparatus as described in claim 11, wherein said actuators are in the form of buttons that each have a symbol thereon that is related to one of the representations associated with said audible sound producing means.

13. The puzzle apparatus as described in claim 12, wherein each of said actuator buttons has a cover on which said symbol is contained so that a plurality of different puzzles can be used with said apparatus, which puzzles can include different representations associated with audible sound producing means.

14. The puzzle apparatus as described in claim 3, wherein said sound means further includes a master actuator to be actuated by a user to produce audible sounds representative of all of said audible sound producing means.

15. The puzzle apparatus as described in claim 3, wherein said sound means further includes a master actuator to be actuated by a user to produce audible sounds representative of a story.

16. A puzzle apparatus comprising:
(a) a first plurality of puzzle pieces that form a first picture when properly combined together that includes a visual representation associated with at least one audible sound producing means, said sound producing means including;
i. a plurality of actuators designed to be individually actuated by a user as desired;
ii. electronic circuitry for producing output signals corresponding to said audible sound producing means;
iii. means for receiving said electronic signals and producing audible sounds corresponding to such signals;
(b) at least a first detectible means associated with at least one of said puzzle pieces;
(c) a platform having a surface on which said puzzle pieces can be arranged and said at least one sound producing means;
(d) detection means associated with said platform and adapted for sensing said at least one detectible means, and providing a first output signal that is representative of said first plurality of puzzle pieces; and
(e) means actuable by a user for receiving said first output signal and activating said at least one sound producing means to produce a first audible sound associated with said at least one visual representation.

17. The puzzle apparatus as described in claim 16, wherein said apparatus further comprises:
(a) a second plurality of puzzle pieces that form a second picture when properly combined together that includes a visual representation associated with at least a second audible sound producing means;
(b) at least a second detectible means associated with at least one of said second plurality of puzzle pieces;
(c) said detection means is associated with said platform and is adapted for sensing said second detectible means and providing a second output signal that is representative of said second plurality of puzzle pieces;
(d) said sound means when actuated by a user is adapted for receiving said second output signal and activating said second audible sound producing means for producing a second audible sound associated with said at least one visual representation of said second picture; and
(e) said first and second plurality of puzzle pieces respectively include a plurality of said detectible means and include a plurality of visual representations associated with said audible sound producing means and said sound producing means is adapted to produce specific audible sounds representative of each of visual representations.

18. The puzzle apparatus as described in claim 17, wherein said detection means is adapted to provide output signals to said sound means to indicate the type of puzzle arranged on said platform.

19. The puzzle apparatus as described in claim 18, wherein each of said actuators is associated with one of the plurality of representations associated with said audible sound producing means so that when a particular one of said actuators is activated by a user, the sound means will produce the specified audible sounds representative of said audible sound producing means.

20. The puzzle apparatus as described in claim 19, wherein said actuators are in the form of buttons that each have a symbol thereon that is related to one of the representations associated with said audible sound producing means, each of said actuator buttons has a cover on which said symbol is contained so that a plurality of different puzzles capable of different representations of audible producing means can be used with said apparatus.
